(19) United States
(12) Patent Application Publication
(10) Pub. No.: US 2010/0153072 A1
(43) Pub. Date: Jun. 17, 2010

(54) INFORMATION PROCESSING APPARATUS, INFORMATION PROCESSING SYSTEM, AND COMPUTER READABLE MEDIUM

(75) Inventor: Junichi TAKEDA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/425,050

(22) Filed: Apr. 16, 2009

(30) Foreign Application Priority Data
Dec. 11, 2008 (JP) 2008-315970

(51) Int. Cl. G06F 17/50; G06F 19/00

(52) U.S. Cl. 703/1; 700/97

(57) ABSTRACT

An information processing apparatus including: an acquisition portion that acquires data indicating a shape of an object, and drawing data on a part to be projected onto the object; a detection portion that detects positions of a tool or the part and a hand or an arm of a user from an image in which a simulated assembly operation of the part is captured in a state where the drawing data is projected onto the object; and a determination portion that determines whether the part is mounted on the object based on the data indicating the shape of the object, the drawing data, and the detected positions of the tool or the part and the hand or the arm of the user.

### CROSS-REFERENCE TO RELATED APPLICATION

This application is based on and claims priority under 35 USC 119 from Japanese Patent Application No. 2008-315970 filed Dec. 11, 2008.

### BACKGROUND

1. Technical Field

This invention relates to an information processing apparatus, an information processing system, and a computer readable medium.

2. Related Art

There has been conventionally known a technique which generates data on a hand when assembly work of parts is executed, and data on a work space necessary to assemble the parts, as CAD (Computer Aided Design) data, and verifies whether the assembly of the parts is possible in CAD software.

In addition, there has been known a technique in which an operator who has put on a head mounted display or a glove with an acceleration sensor simulates the assembly of parts on a virtual space.

### SUMMARY

According to an aspect of the present invention, there is provided an information processing apparatus including: an acquisition portion that acquires data indicating a shape of an object, and drawing data on a part to be projected onto the object; a detection portion that detects positions of a tool or the part and a hand or an arm of a user from an image in which a simulated assembly operation of the part is captured in a state where the drawing data is projected onto the object; and a determination portion that determines whether the part is mounted on the object based on the data indicating the shape of the object, the drawing data, and the detected positions of the tool or the part and the hand or the arm of the user.

### BRIEF DESCRIPTION OF THE DRAWINGS

Exemplary embodiments of the present invention will be described in detail based on the following figures, wherein:

FIG. 1 is a block diagram showing the structure of an information processing system in accordance with an exemplary embodiment of the present invention;

FIG. 2 is a block diagram showing the hardware structures of a server 1 and a client 2;

FIG. 3 is a flowchart showing a simulation process executed by the information processing system;

FIG. 4A is a diagram showing an operation in which a user makes a tool 20 come in contact with a screw-fastening section 9a;

FIG. 4B is a diagram showing an operation in which a member 21 is installed on CAD data;

FIG. 4C is a diagram showing an operation in which an arm of the user comes in contact with a protruding part 8a;

FIG. 5A is a diagram showing an example of mounting a member 22 on an object 8;

FIG. 5B is a diagram showing a state where CAD data 23 of the member 22 is projected onto the object 8;

FIG. 6 is a diagram showing a CAD application executed with the server 1 or the client 2; and

FIGS. 7A to 7D are diagrams showing an arrangement relationship between the object 8, the CAD data 23, and the arm of the user when the user screws up screw-fastening sections 23a.

### DETAILED DESCRIPTION

A description will now be given, with reference to the accompanying drawings, of exemplary embodiments of the present invention.

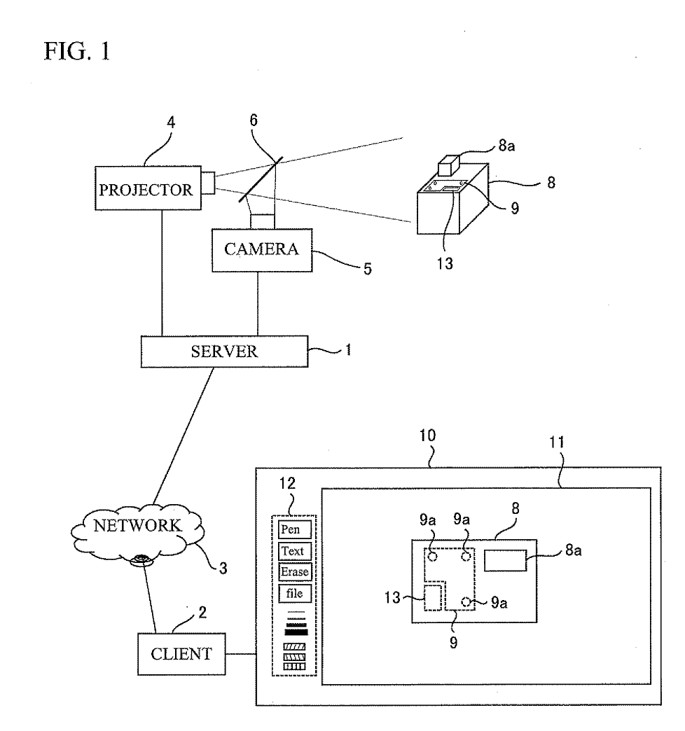

FIG. 1 is a block diagram showing the structure of an information processing system in accordance with an exemplary embodiment of the present invention.

The information processing system in FIG. 1 includes a server 1 as an information processing apparatus, and a client 2. These elements are connected to each other via a network 3. The server 1 and the client 2 are composed of computers.

The server 1 is connected to a projector 4 and a camera 5. Based on a control command from the server 1, the projector 4 projects an annotation image input from the client 2 onto an object 8 via a half mirror 6. It should be noted that the annotation image includes an image of any types such as a line, a character, a symbol, a figure, a color, and a font. The object 8 has a protruding part 8a as shown in FIG. 1.

The camera 5 is composed of a video camera, captures a reflected image of a capture area including the object 8 via the half mirror 6, and outputs the captured image to the server 1. That is, the camera 5 captures a whole image of the object 8. The half mirror 6 makes angles of view and optical axes of the projector 4 and the camera 5 identical with each other.

The server 1 stores the captured image of the camera 5. The server 1 delivers the captured image to the client 2 depending on a delivery request of the captured image from the client s. In addition, the server 1 acquires the annotation image from the client 2, and outputs the annotation image to the projector 4.

The server 1 inputs a control command for the projector 4 from the client 2 via the network 3, and controls the brightness of an image projected by the projector 4, a projection position of the projector 4, and so on. In addition, the server 1 inputs a control command for the camera 5 from the client 2 via the network 3, and controls a capture angle of the camera 5, the brightness of the captured image, capture timing, and so on.

A display device 10 is connected to the client 2, and displays a display area 11 and a user interface (UI) 12. The client 2 may be a computer that is integrated with the display device 10.

The UI 12 includes a group of buttons such as a pen button, a text button, and an erase button, and icons defined by lines and colors. In FIG. 1, the image of the object 8 captured by the camera 5 are displayed on the display area 11. Moreover, CAD (Computer Aided Design) data (i.e., drawing data) 9 and 13 of parts to be mounted on the object 8 are displayed on the object 8 in the display area 11. When a user designates display regions, depresses a file button in the UI 12, and selects the CAD data 9 and 13 of the desired parts, the selected CAD data 9 and 13 are displayed on the designated display regions. In FIG. 1, a reference number 9a indicates a screw-fastening section. The CAD data 9 and 13 displayed on the display area 11 are transmitted to the projector 4 via the client 2 and the server 1. The projector 4 projects the CAD data 9 and 13 onto the object 8.

For example, when the pen button in the UI 12 is depressed and the annotation image is drawn on the object 8 in the display area 11, the information on the annotation image (specifically, coordinate data) is output from the client 2 to the server 1. The server 1 decodes the information on the annotation image, converts the decoded information into a projection image for the projector 4, and outputs the projection image to the projector 4. The projector 4 projects the projection image onto the object 8.

In FIG. 1, the information processing system includes the single client 2, but the information processing system may include two or more clients (PCs). The server 1 may be composed of two or more computers.

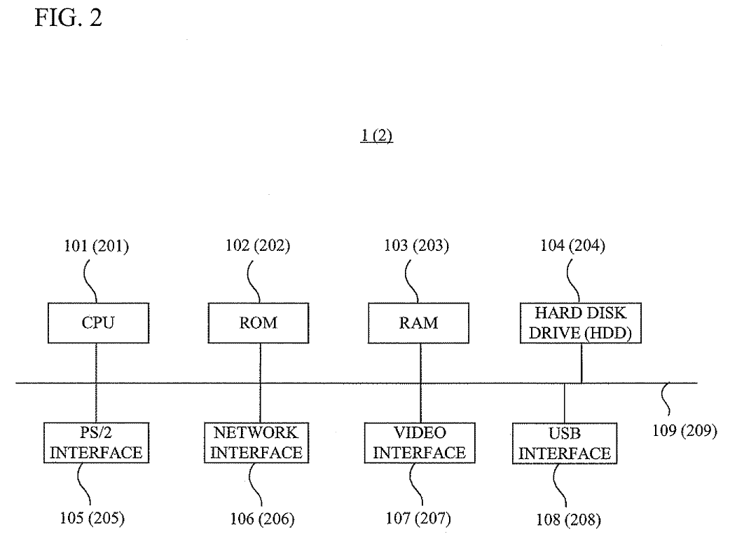

FIG. 2 is a block diagram showing the hardware structures of the server 1 and the client 2. Since the hardware structure of the server 1 is the same as that of the clients, a description will now be given of the hardware structure of the server 1 hereinafter. It should be noted that, in FIG. 2, the reference numerals 201 to 209 designate the elements of the client 2.

The server 1 includes: a CPU 101 that controls the entire server 1; a ROM 102 that stores control programs; a RAM 103 that functions a working area; a hard disk drive (HDD) 104 that stores various information and programs; a PS/2 interface 105 that is connected to a mouse and a keyboard, not shown; a network interface 106 that is connected to other computers; a video interface 107 that is connected to a display device; and a USB (Universal Serial Bus) interface 108 that is connected to a USB device, not shown. The CPU 101 is connected to the ROM 102, the RAM 103, the HDD 104, the PS/2 interface 105, the network interface 106, the video interface 107 and the USB interface 108 via a system bus 109.

It is assumed that the CAD data 9 and 13 are stored into any one of the HDD 104, the HDD 204, or an external storage device (not shown) connected to the network 3. It is assumed that coordinate data indicating a shape of the object 8 is also stored into any one of the HDD 104, the HDD 204, or an external storage device (not shown) connected to the network 3.

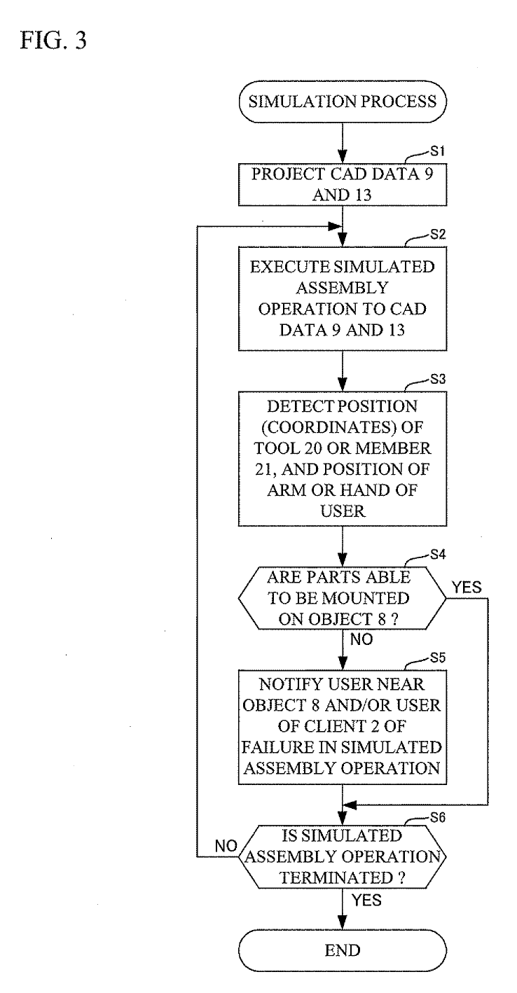

FIG. 3 is a flowchart showing a simulation process executed by the information processing system. In the process, a simulation to mount certain parts (screws, members, and so on) on the object 8 is executed.

First, the CPU 101 of the server 1 outputs the CAD data 9 and 13 to the projector 4 in response to a directly input projection instruction of the CAD data 9 and 13 or a projection instruction of the CAD data 9 and 13 from the client 2, and causes the projector 4 to project the CAD data 9 and 13 onto the object 8 (step S1). The CAD data 9 and 13 output to the projector 4 may be stored into the HDD 104, received from the client 2, or read out from the external storage device connected to the network 3.

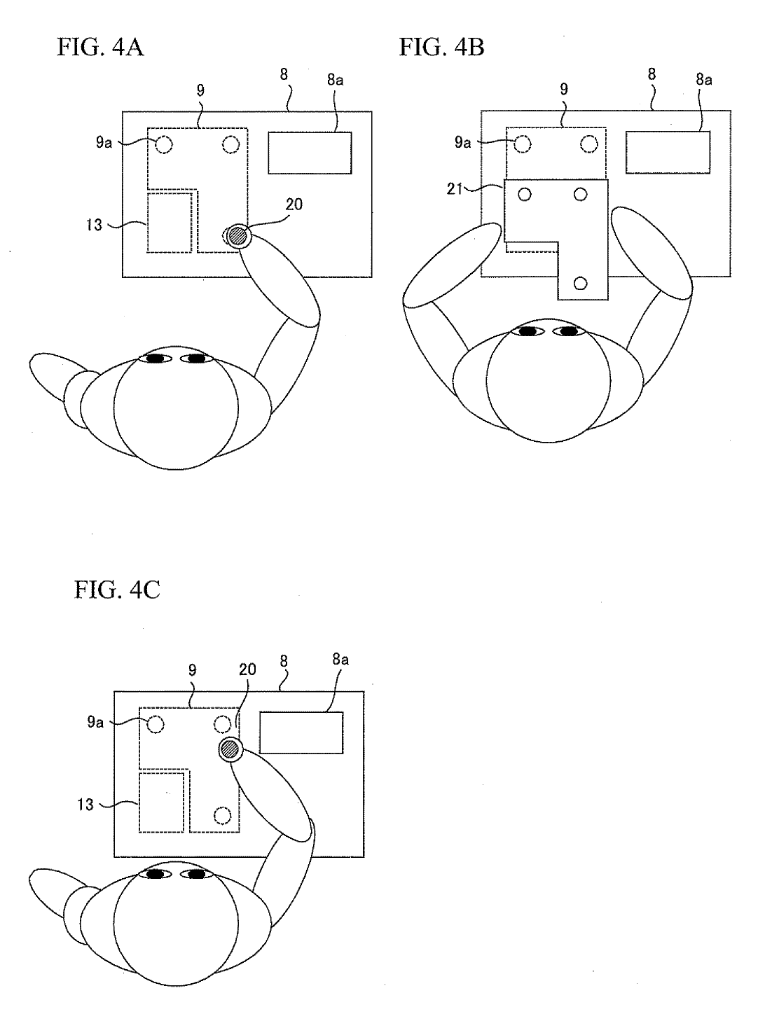

Next, the user near the object 8 executes a simulated assembly operation to the CAD data 9 and 13 which have projected onto the object 8 (step S2). The simulated assembly operation includes an operation in which the user makes a tool 20 such as a driver come in contact with a screw-fastening section 9a in the CAD data 9, as shown in FIG. 4A, and an operation to locate a member 21 on the CAD data 9, as shown in FIG. 4B, for example. In this case, a specific mark is applied to the tool 20 or the member 21 in advance. Further, a specific mark is also applied to a position of an arm or a hand of the user. It should be noted that the tool 20 includes a jig as an assistant tool.

Next, the CPU 101 matches the specific mark applied to the tool 20 or the member 21 with the captured image of the simulated assembly operation, detects a position (i.e., coordinates) of the tool 20 or the member 21, and detects the position of the arm or the hand of the user from the captured image by the camera 5 based on the specific mark applied to the position of the arm or the hand of the user (step S3).

The CPU 101 may detect the position (i.e., coordinates) of the tool 20 or the member 21 by matching the captured image from the camera 5 with a previously captured image of the tool 20 or the member 21. Further, the CPU 101 may detect the position of the arm or the hand of the user by matching the captured image from the camera 5 with a previously captured image of the arm or the hand of the user.

The CPU 101 determines whether the parts including screws and the member 21 are able to be mounted on the object 8, based on the coordinate data indicating the shape of the object 8, the CAD data to be projected onto the object 8, the detected position of the tool 20 or the member 21, and the detected position of the arm or the hand of the user (step S4).

Specifically, when the detected coordinates of the tool 20 overlaps with the coordinates of the screw-fastening section 9a in the CAD data 9, and the arm or the hand of the user does not come in contact with the protruding part 8a, the CPU 101 determines that the screws are able to be mounted or fastened on the object 8. In this case, the CPU 101 decides the position of the protruding part 8a from the coordinate data indicating the shape of the object 8, which is previously stored into the HDD 104, or the like.

On the other hand, the detected coordinates of the tool 20 do not overlap with the coordinates of the screw-fastening section 9a in the CAD data 9, or the arm or the hand of the user comes in contact with the protruding part 8a, the CPU 101 determines that the screws are not able to be mounted or fastened on the object 8. For example, when the arm of the user comes in contact with the protruding part 8a, as shown in FIG. 4C, the coordinates of the tool 20 do not overlap with the coordinates of the screw-fastening section 9a in the CAD data 9 projected onto the object 8.

Similarly, in the case of the member 21, when the detected coordinates of the member 21 overlaps with the coordinates of the CAD data 13 (i.e., the CAD data corresponding to parts other than the member 21) projected onto the object 8, or the member 21 comes in contact with the protruding part 8a, the CPU 101 determines that the part (i.e., the member 21) is not able to be mounted on the object 8. When the detected coordinates of the member 21 does not overlap with the coordinates of the CAD data 13 (i.e., the CAD data corresponding to parts other than the member 21) projected onto the object 8, and the member 21 does not come in contact with the protruding part 8a, the CPU 101 determines that the part (i.e., the member 21) is able to be mounted on the object 8.

Next, when the answer to the determination of step S4 is “NO”, the CPU 101 notifies the user near the object 8 and/or the user of the client 2 of the failure in the simulated assembly operation (step S5). Specifically, the CPU 101 causes the projector 4 to protect a warning image, blinks the CAD data 9 and 13 projected onto the object 8 on and off, and outputs a warning sound from speakers (not shown) connected to the server 1 and the client 2. Thereby, the user near the object 8 and/or the user of the client 2 are notified of the failure in the simulated assembly operation. When the answer to the determination of step S4 is “YES”, the procedure proceeds to step S6.

Finally, the CPU 101 determines whether the simulated assembly operation is terminated (step S6). Specifically, the CPU 101 determines that the simulated assembly operation is terminated when the coordinates of the tool 20 have overlapped with the coordinates of all screw-fastening sections 9a, or a termination instruction of the simulated assembly operation has been input to the CPU 101.

When the answer to the determination of step S6 is “YES”, the present process is terminated. On the other hand, when the answer to the determination of step S6 is “NO”, the procedure returns to step S2.

Although in the exemplary embodiment, the specific mark is applied to the tool 20 or the member 21 in advance, the user previously sets a given position to a given application executed with the CPU 101 from the server 1 or the client 2, and the CPU 101 may determine whether the part is able to be mounted on the object 8, by detecting the change of a state at the set position in the captured image (e.g. the change in at least one color information on hue, brightness or saturation). For example, the user sets in advance the coordinates of the screw-fastening section 9a in the CAD data 9 to the given application executed with the CPU 101, by using a keyboard (not shown) of the server 1, and when the color information corresponding to the set coordinates of the screw-fastening section 9a in the captured image is changed, the CPU 101 may determine that the part is able to be mounted on the object 8.

### VARIATION EXAMPLE

It is assumed that, in a variation example, a member 22 is mounted on the object 8.

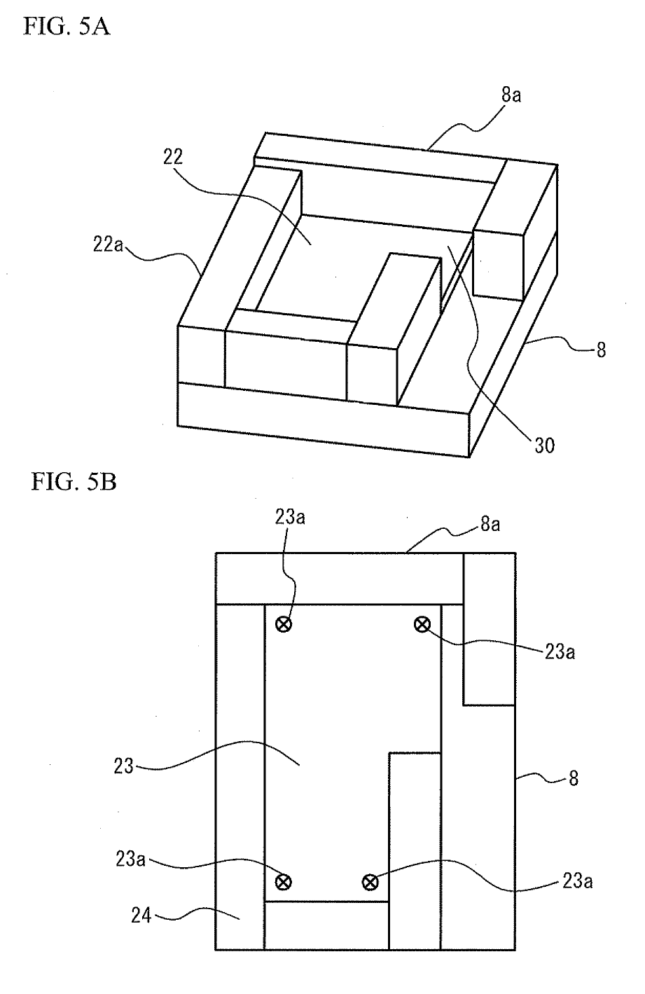

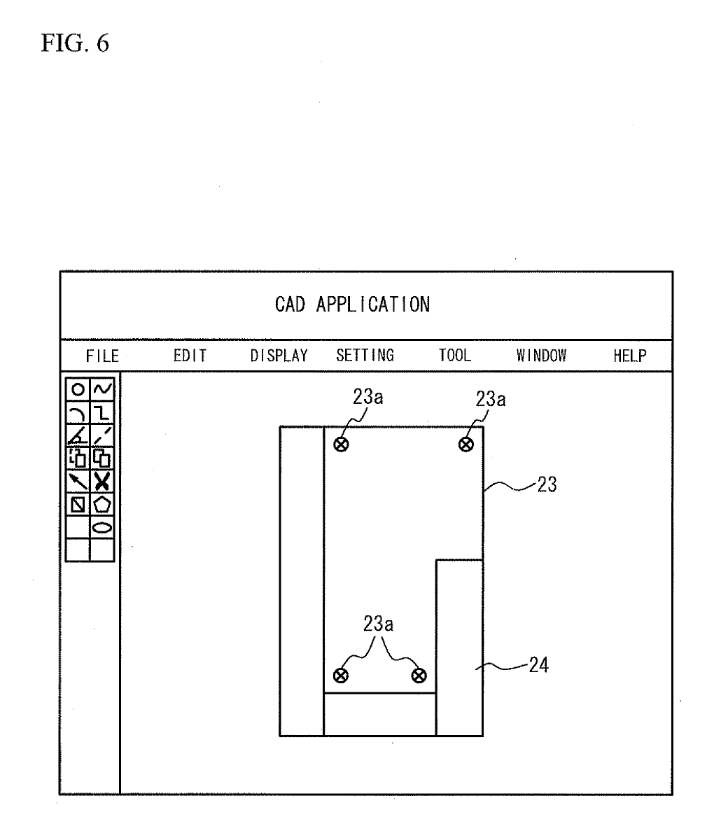

FIG. 5A is a diagram showing an example of mounting the member 22 on the object 8, and FIG. 5B is a diagram showing a state where CAD data 23 of the member 22 is projected onto the object 8. FIG. 6 is a diagram showing a CAD application executed with the server 1 or the client 2.

As shown in FIG. 5A, a protruding part 8a is provided on the object 8, and a protruding part 22a is also provided on the member 22. It is assumed that, in such a state, the user inserts the hand or the arm into the inside of the member 22 from a space 30 between the protruding part 8a and the protruding part 22a.

On the CAD application in FIG. 6, the CAD data 23 corresponding to the member 22 is displayed. A plurality of screw-fastening sections 23a and an block area 24 corresponding to the protruding part 22a are included in the CAD data 23. The user produces the CAD data 23 by using the CAD application, and sets the block area 24. The CAD application in FIG. 6 and the produced CAD data 23 are stored into any one of the HDD 104, the HDD 204, and the external storage device (not shown) connected to the network 3. When the CPU 101 reads out the CAD data 23, the setting of the block area 24 is read out at the same time.

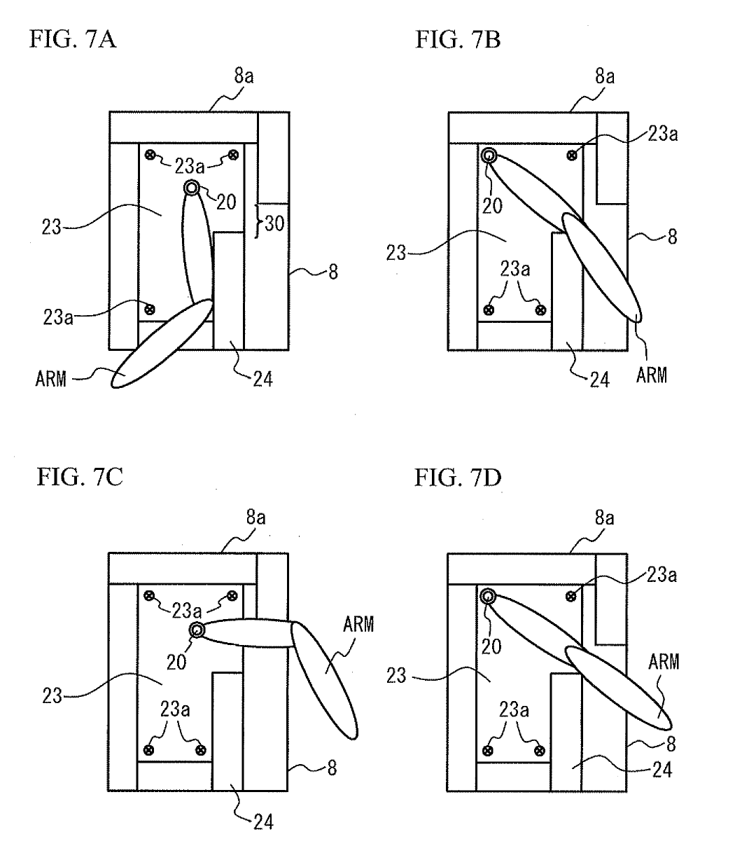

FIGS. 7A to 7D are diagrams showing an arrangement relationship between the object 8, the CAD data 23, and the arm of the user when the user screws up screw-fastening sections 23a.

In the variation example, the above-mentioned process in FIG. 3 is also executed. In step S4 of FIG. 3, the CPU 101 reads out the coordinate data indicating the shape of the object 8, the CAD data 23, and the position of the block area 24 from any one of the HDD 104, the HDD 204, and the external storage device (not shown) connected to the network 3, and determines whether the parts (e.g. screws) are able to be mounted or fastened on the object 8, based on the reed-out coordinate data indicating the shape of the object 8, the CAD data 23 and the position of the block area 24, and the positions of the tool 20 and the arm or the hand of the user detected from the captured image.

For example, in FIG. 7A, the arm of the user overlaps with the block area 24, and hence the CPU 101 determines that the screws are not able to be mounted or fastened on the object 8 in step S4 of FIG. 3. Although in FIG. 7E, the coordinates of the tool 20 overlap with the coordinates of one of the screw-fastening sections 23a, the arm of the user overlaps with the block area 24. Therefore, the CPU 101 determines that the screws are not able to be mounted or fastened on the object 8 in step S4 of FIG. 3.

In FIG. 7C, the arm of the user overlaps with the protruding part 8a, and hence the CPU 101 determines that the screws are not able to be mounted or fastened on the object 8 in step S4 of FIG. 3. In FIG. 7D, the arm of the user overlaps with the block area 24 and the protruding part 8a, and the coordinates of the tool 20 overlap with one of the coordinates of the screw-fastening sections 23a (here, it is assumed that the coordinates of the tool 20 overlap with the remaining coordinates of the screw-fastening sections 23a). Therefore, the CPU 101 determines that the screws are able to be mounted or fastened on the object 8 in step S4 of FIG. 3.

As described in detail above, according to the exemplary embodiment, the CPU 101 acquires the coordinate data indicating the shape of the object 8, and the CAD data 23 to be projected onto the object 8 from any one of the HDD 104, the HDD 204, and the external storage device (not shown) connected to the network 3, detects the positions of the tool 20 or the screws, the member 21, and the arm or the hand of the user from the image in which the simulated assembly operation of the parts is captured in a state where the CAD data is projected onto the object 8, and determines whether the parts are mounted or fastened on the object 8 based on the coordinate data indicating the shape of the object 8, the CAD data 23 to be projected onto the object 8 (i.e., drawing data), and the detected positions of the tool 20 or the screws, the member 21, and the arm or the hand of the user.

Therefore, the server 1 verifies whether the parts can be assembled on the CAD data of the parts projected onto the object 8.

When the positions of the tool 20 or the screws and the member 21 overlaps with the preset positions on the CAD data (i.e., the positions of the screw-fastening sections 9a and 23a, or the CAD data 9 and 13), and the position of the hand or the arm of the user does not come in contact with the object 8, the CPU 101 determines that the parts are mounted or fastened on the object 8. On the other hand, when the positions of the tool 20 or the screws and the member 21 do not overlap with the preset positions on the CAD data, or the position of the hand or the arm of the user comes in contact with the object 8, the CPU 101 determines that the parts are not mounted or fastened on the object 8. Therefore, the CPU 101 verifies whether the parts can be assembled based on a relationship between the positions of the tool 20 or the screws and the member 21, and the preset positions on the CAD data, and a contact relationship between the hand or the arm of the user and the object 8.

When the CPU 101 sets into the CAD data the block area 24 indicating a block to the tool 20 or the screws, the member 21, or the hand or the arm of the user, and if the positions of the tool 20 or the screws and the member 21 overlaps with the preset positions on the CAD data (i.e., the positions of the screw-fastening sections 9a and 23a, or the CAD data 9 and 13), and the position of the hand or the arm of the user does not come in contact with the object 8 and the block area 24, the CPU 101 determines that the parts are mounted or fastened on the object 8. On the other hand, when the CPU 101 sets into the CAD data the block area 24 indicating the block to the tool 20 or the screws, the member 21, or the hand or the arm of the user, and if the positions of the tool 20 or the screws and the member 21 do not overlap with the preset positions on the CAD data, or the position of the hand or the arm of the user comes in contact with the object 8 or the block area 24, the CPU 101 determines that the parts are not mounted or fastened on the object 8. Therefore, the CPU 101 verifies whether the parts can be assembled based on the relationship between the positions of the tool 20 or the screws and the member 21, and the preset positions on the CAD data, and a contact relationship between the hand or the arm of the user and the object 8 or the block area 24.

A recording medium on which the software program for realizing the functions of the server 1 is recorded may be supplied to the server 1, and the CPU 101 may read and execute the program recorded on the recording medium. In this manner, the same effects as those of the above-described exemplary embodiment can be achieved. The recording medium for providing the program may be a CD-ROM, a DVD, or a SD card, for example.

Alternatively, the CPU 101 of the server 1 may execute a software program for realizing the functions of the server 1, so as to achieve the same effects as those of the above-described exemplary embodiment.

It should be noted that the present invention is not limited to those exemplary embodiments, and various modifications may be made to them without departing from the scope of the invention.

What is claimed is:

1. An information processing apparatus comprising:
an acquisition portion that acquires data indicating a shape of an object, and drawing data on a part to be projected onto the object;
a detection portion that detects positions of a tool or the part and a hand or an arm of a user from an image in which a simulated assembly operation of the part is captured in a state where the drawing data is projected onto the object; and
a determination portion that determines whether the part is mounted on the object based on the data indicating the shape of the object, the drawing data, and the detected positions of the tool or the part and the hand or the arm of the user.

2. The information processing apparatus according to claim 1, wherein when the position of the tool or the part overlaps with a preset position on the drawing data, and the position of the hand or the arm of the user does not come in contact with the object, the determination portion determines that the part is mounted on the object, and
when the position of the tool or the part does not overlap with the preset position on the drawing data, or the position of the hand or the arm of the user comes in contact with the object, the determination portion determines that the part is not mounted on the object.

3. The information processing apparatus according to claim 1, further comprising a setting portion that sets a block area indicating a block to the tool or the part, or the hand or the arm of the user, into the drawing data,
wherein when the position of the tool or the part overlaps with the preset position on the drawing data, and the position of the hand or the arm of the user does not come in contact with the object and the block area, the determination portion determines that the part is mounted on the object, and
when the position of the tool or the part does not overlap with the preset position on the drawing data, or the position of the hand or the arm of the user comes in contact with the object, the determination portion determines that the part is not mounted on the object.

4. The information processing apparatus according to claim 1, further comprising a notification portion that notifies the user that the part is not mounted on the object when the determination portion determines that the part is not mounted on the object.

5. An information processing system comprising:
a first information processing apparatus that stores data indicating a shape of an object, and drawing data on a part to be projected onto the object; and
a first information processing apparatus including:
an acquisition portion that acquires the data indicating the shape of the object, and the drawing data on the part to be projected onto the object;
a detection portion that detects positions of a tool or the part and a hand or an arm of a user from an image in which a simulated assembly operation of the part is captured in a state where the drawing data is projected onto the object; and
a determination portion that determines whether the part is mounted on the object based on the data indicating the shape of the object, the drawing data, and the detected positions of the tool or the part and the hand or the arm of the user.

6. A computer readable medium causing a computer to execute a process, the process comprising:
acquiring data indicating a shape of an object, and drawing data on a part to be projected onto the object;
detecting positions of a tool or the part and a hand or an arm of a user from an image in which a simulated assembly operation of the part is captured in a state where the drawing data is projected onto the object; and
determining whether the part is mounted on the object based on the data indicating the shape of the object, the drawing data, and the detected positions of the tool or the part and the hand or the arm of the user.
